(19) United States
(12) Patent Application Publication
(10) Pub. No.: US 2006/0073460 A1
(43) Pub. Date: Apr. 6, 2006

(54) Method and system for achievement test preparation

(76) Inventor: Holly A. Holubec, Austin, TX (US)

Correspondence Address: MICHAEL O. SCHEINBERG, P.O. BOX 164140, AUSTIN, TX, 78716-4140, US

(21) Appl. No.: 10/935,597

(22) Filed: Sep. 7, 2004

(51) Int. Cl. G09B 3/00

(52) U.S. Cl. 434/322

(57) ABSTRACT

Provided herein is a method for preparing a class group of students for taking an achievement test in a subject. The test includes a plurality of questions directed to a plurality of different test subject categories relating to the subject. In one embodiment, the method comprises the following acts. A set of subject measures is defined. Each measure corresponds to one or more of the subject categories. The number of subject measures in the set is sufficiently less than the number of different subject categories. Each student in the class group is provided with a learning aid for each measure. The students are presented with one or more assessment tests throughout a school year in preparation for the achievement test. Each student is administered a chart to track his/her performance for each measure on the assessment tests. The students are then caused to use the learning aids in connection with their charted measure scores when the subject is being taught to the class group.

### TECHNICAL FIELD

This disclosure relates generally to educational materials and in particular to an improved method for teaching students and preparing them for standardized, achievement tests.

### BACKGROUND

Within the United States, the use of standardized achievement tests to determine whether or not a student can advance in grades is becoming more pervasive. Even on the elementary level, students are required to pass achievement tests in subjects such as math and reading before they are allowed to progress to the next grade level.

As an example, in Texas, the Texas Assessment of Knowledge and Skills (TAKS™) tests are now being administered for students in grades 3 through 12. In grade three, for example, standardized achievement tests for reading and math are administered to students. In some cases, such achievement tests must be passed before a student can advance to the next grade level. The tests are structured to test students based on general reading and math objectives as set forth by the Texas Education Agency (“TEA”). These objectives generally apply to all of the grade levels with different, specific expectations defined for each grade level. For reading, the general objectives are: (1) the student will demonstrate a basic understanding of culturally diverse written texts; (2) the student will apply knowledge of literary elements to understand culturally diverse written texts; (3) the student will use a variety of strategies to analyze culturally diverse written texts; and (4) the student will apply critical-thinking skills to analyze culturally diverse written texts. Likewise, for math, the general objectives are: (1) the student will demonstrate an understanding of numbers, operations, and quantitative reasoning; (2) the student will demonstrate an understanding of patterns, relationships, and algebraic reasoning; (3) the student will demonstrate an understanding of geometry and spatial reasoning; (4) the student will demonstrate an understanding of the concepts and uses of measurement; (5) the student will demonstrate an understanding of probability and statistics; and (6) the student will demonstrate an understanding of the mathematical processes and tools used in problem solving.

From these objectives, for each grade level, specific expectations have been defined for testing in the Texas Assessment of Knowledge and Skills (“TAKS”) test. (For additional information regarding these expectations including sample questions pertaining to the same. see, e.g., Information Booklet, Reading, Grade 3, Texas Education Agency—Student Assessment Division [January 2002], and Information Booklet, Mathematics, Grade 3, Texas Education Agency—Student Assessment Division [January 2002]). Listed below in tables I and II are test categories directly corresponding to the defined expectations for the grade three reading and math TAKS tests.

TABLE I
Reading Test Categories

| | Reading Test | |
|---|---|---|
| | Category | Description |
| 1 | Word Study I | Measures knowledge of figurative language |
| 2 | Word Study II | Use of root words and other structural |
| | | clues to identify words |
| 3 | Word Study III | Word order and context to identify words |
| 4 | Comprehension I | Graphic organizers to retell events of stories |
| 5 | Comprehension II | Determine how text main idea is supported |
| | | by details |
| 6 | Comprehension III | Summaries of text selection |
| 7 | Variety of Texts | Read from a variety of genres and |
| | | acquire information from both print |
| | | and electronic formats |
| 8 | Analysis and | Use graphic organizers to determine |
| | Evaluation I | character traits |
| 9 | Analysis and | Identify importance of setting to a |
| | Evaluation II | story's meaning |
| 10 | Analysis and | Recognizing story's problem(s) and plot |
| | Evaluation III | |
| 11 | Text Structure I | Distinguish different forms of text and |
| | | the structure they serve |
| 12 | Text Structure II | Recognize features of familiar genres |
| 13 | Comprehension IV | Make and explain inferences from texts |
| 14 | Literary Response | Support interpretation or conclusion with |
| | | examples from text |
| 15 | Fluency I | Student reads regularly in independent |
| | | materials with accuracy |
| 16 | Fluency II | Students reads fluently in instructional |
| | | materials |

TABLE II
Math Test Categories

| | Math Test Category | Description |
|---|---|---|
| 1 | Place Value, Comparing | Use place value to solve the value |
| | and Ordering I | for a whole number |
| 2 | Place Value, Comparing | Use place value to compare and |
| | and Ordering II | order whole numbers |
| 3 | Place Value, Comparing | Rounding 2 and 3 digit numbers to |
| | and Ordering III | the nearest ten and hundred |
| 4 | Place Value, Comparing | Compare fractional parts of whole |
| | and Ordering IV | objects or sets of whole objects |
| 5 | Place Value, Comparing | Determining the value of a collection |
| | and Ordering V | of coins and bills |
| 6 | Number | Use fraction names and symbols with |
| | | denominators of 12 or less |
| 7 | Problem Solving & | Use pictures, words and numbers for |
| | Operations I | addition and subtraction |
| 8 | Problem Solving & | Select addition or subtraction and |
| | Operations II | use the operation to solve |
| | | problems to 999 |
| 9 | Problem Solving & | Solve multiplication problems |
| | Operations III | |
| 10 | Problem Solving & | Use models to solve division problems |
| | Operations IV | and use number sentences to record |
| | | the solutions |
| 11 | Problem Solving & | Estimate sums and differences beyond |
| | Operations V | basic facts |
| 12 | Patterns, Relationships, | Identify patterns in |
| | and Algebraic Thinking I | multiplication facts |
| 13 | Patterns, Relationships, | Identify patterns in related |
| | and Algebraic Thinking II | multiplication and/or division |
| | | sentences |
| 14 | Patterns, Relationships, | Identify whole numbers and geometric |
| | and Algebraic Thinking III | patterns to predict and solve problems |
| 15 | Patterns, Relationships, | Generate a table of paired numbers |
| | and Algebraic Thinking IV | based on real life situations |
| 16 | Patterns, Relationships, | Identify patterns in a table of related |
| | and Algebraic Thinking V | number pairs and extend the table |
| 17 | Geometric Properties | Compare shapes and solids using |
| | | formal geometric vocabulary |
| 18 | Graphing and | Locate and name whole numbers |
| | Transformation I | on a line using whole numbers |
| | | and fractions |
| 19 | Graphing and | Identify lines of symmetry in shapes |
| | Transformation II | |
| 20 | Graphing and | Identify congruent shapes |
| | Transformation III | |
| 21 | Time and Temperature | Use a temperature to measure |
| | | temperature |
| 22 | Time and Temperature | Identify time on a digital or |
| | | traditional clock |
| 23 | Estimate I | Estimate lengths using standard units |
| 24 | Estimate II | Use concrete models of square units |
| | | to determine the areas of shapes |
| 25 | Solving Problems | Use linear measure to find the |
| | Using Measurement I | measure of a shape |
| 26 | Solving Problems | Solve problems involving length, area, |
| | Using Measurement II | temperature, and time |
| 27 | Probability | Use date to describe events as more |
| | | likely, less likely, or equally likely |
| 28 | Displaying and | Organize data in pictogrraphs and |
| | Interpreting Data | or/bar graphs for more than one |
| | | data entry |
| 29 | Displaying and | Interpret information from pictogrraphs |
| | Interpreting Data | and/or bar graphs |
| 30 | Problem Solving | Identify the mathematics in everyday |
| | | situations |
| 31 | Problem Solving | Use a problem solving model that |
| | | incorporates reasonableness |
| 32 | Problem Solving | Select or develop an appropriate |
| | | problem solving strategy |
| 33 | Problem Solving | Relate informal language into |
| | | mathematical language and symbols |
| 34 | Problem Solving | Make generalizations from patterns |
| | | or sets of examples and non-examples |

For reading, categories/expectations 1-7 correspond to the first objective; categories/expectations 8-10 correspond to the second objective, categories/expectations 11-12 correspond to the third objective; and categories/expectations 13-16 correspond to the fourth objective. Likewise, for math, categories/expectations 1-12 correspond to objective 1; categories/expectations 13-16 correspond to objective 2; categories/expectations 17-20 correspond to objective 3; categories/expectations 21-26 correspond to objective 4; categories/expectations 27-29 correspond to objective 5; and categories/expectations 30-34 correspond to objective 6. The TAKS reading and math tests each include questions directed to these expectations (or categories). That is, each category/expectation is generally represented in the standardized tests with one or more questions directed to it.

There are several challenges associated with teaching students, especially younger students such as third graders, in these areas suitably well for most, if not all, of the students to pass the achievement tests. For example, there is a natural disconnect between the normal, day-to-day classroom instruction, on the one hand, and an achievement test, on the other hand, with its unique format and high-pressure setting, given one time at the end of the year. Consequently, in many districts, assessment tests(e.g., sample tests) are given at the end of each quarter to monitor the students' readiness to take and pass the test. The assessment tests work well because they not only track a student's test-taking ability, but also, they provide the students with experience under actual achievement test conditions. At the same time, however, teachers need to teach the regular curriculums for each subject and not spend most or all of their time simply “teaching to the test.” Normally, a teacher is required to teach according to a pre-defined curriculum whose areas may overlap with some of the test subject categories but not necessarily enough to meaningfully prepare most of the students for the specific test categories and in the form presented on the achievement test.

Accordingly, what is needed is an improved scheme for preparing class groups of students for achievement tests within the context of normal curriculum instruction.

### SUMMARY

Provided herein is a method for preparing a class group of students for taking an achievement test in a subject. The test includes a plurality of questions directed to a plurality of different test subject categories relating to the subject. In one embodiment, the method comprises the following acts. A set of subject measures is defined. Each measure corresponds to one or more of the subject categories. The number of subject measures in the set is sufficiently less than the number of different subject categories. Each student in the class group is provided with a learning aid for each measure. The students are presented with one or more assessment tests throughout a school year in preparation for the achievement test. Each student is administered a chart to track his/her performance for each measure on the assessment tests. The students are then caused to use the learning aids in connection with their charted measure scores when the subject is being taught to the class group.

The foregoing has outlined rather broadly some of the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes as the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, the following description is made with reference to the accompanying drawings, in which:

FIG. 1 is a chart showing subject measures mapped to subject categories for a teaching method used to prepare students for a grade three TAKS reading test according to one embodiment of the present invention.

FIGS. 2A-2G show laminated sheet learning aids corresponding to the subject measures used in the teaching method of FIG. 1.

FIG. 3 shows a chart for tracking student assessment test performances in connection with the teaching method of FIGS. 1 and 2A-G.

FIGS. 4A and 4B show a chart illustrating subject measures mapped to subject test categories for a teaching method used to prepare students for a grade three TAKS math test according to one embodiment of the present invention.

FIGS. 5A-5K show laminated sheet learning aids corresponding to the subject measures used in the teaching method of FIGS. 4A and 4B.

FIG. 6 shows a chart for tracking student assessment test performances in connection with the teaching method of FIGS. 4A,B and 5A-K.

FIG. 7 shows an exemplary math test strategies learning aid.

### DETAILED DESCRIPTION

With the techniques discussed herein, a scheme for better preparing students in a classroom for taking and passing standardized, achievement tests is presented. The method integrates the teaching of test subject category skills into normal classroom curriculum instruction. In this way, teachers can vastly improve their students' achievement test performances without having to take excessive time away from the normal instruction.

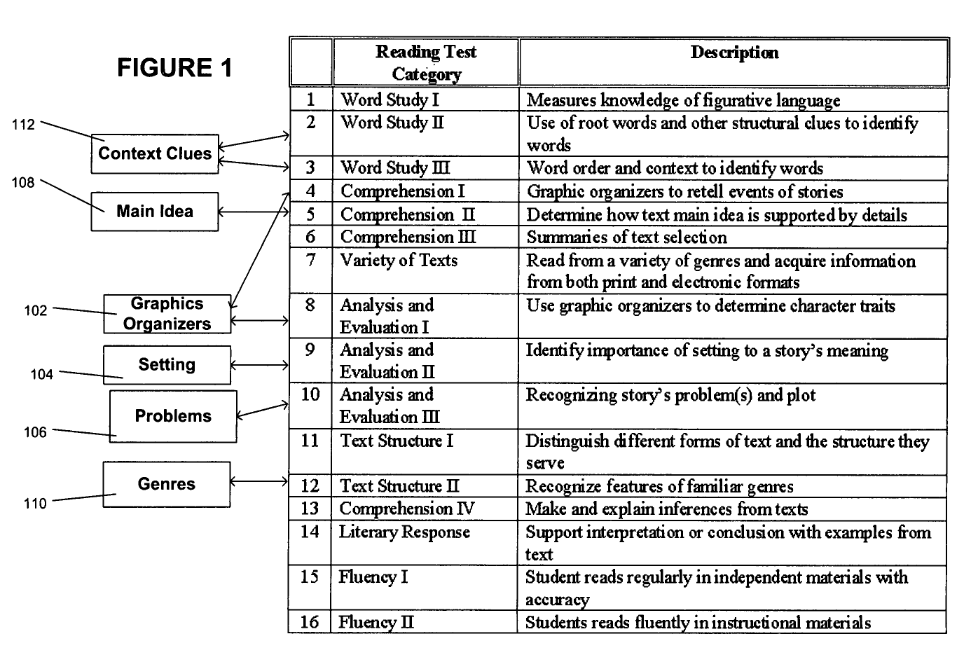

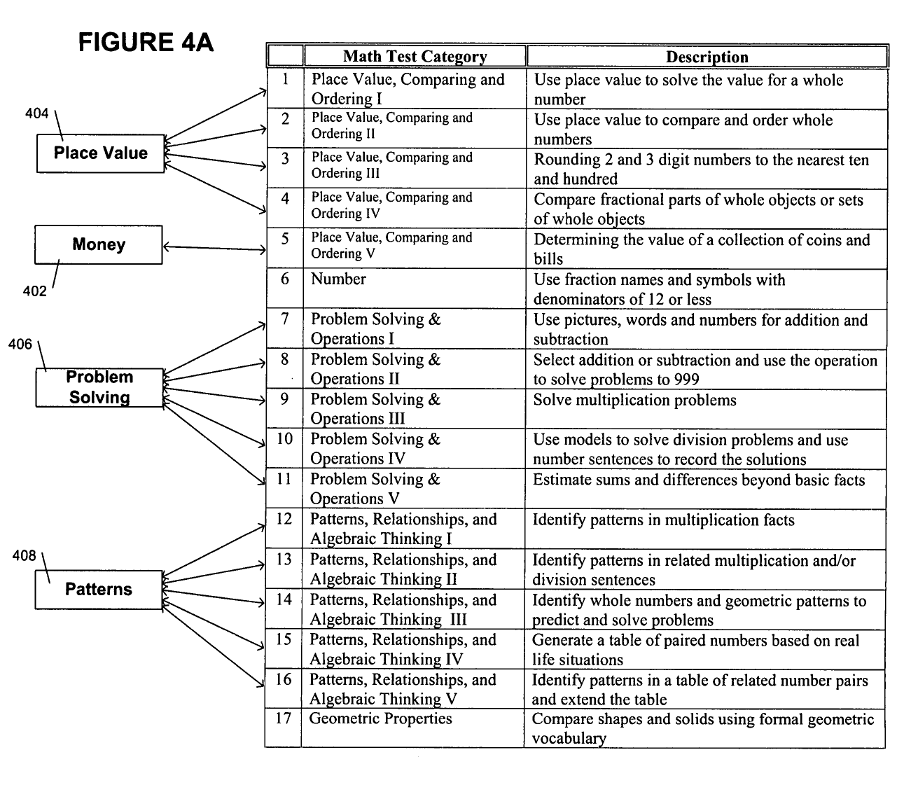

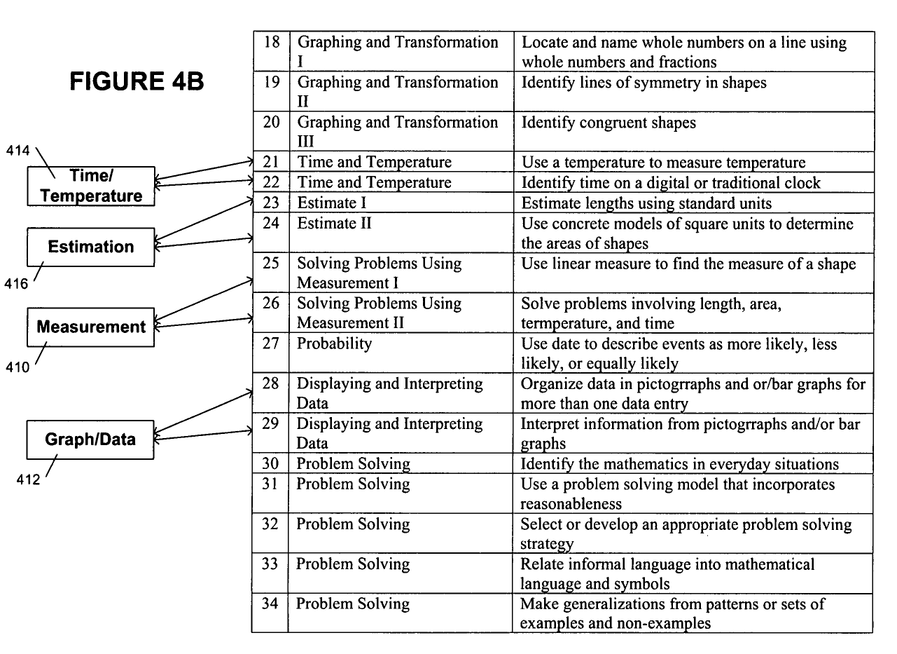

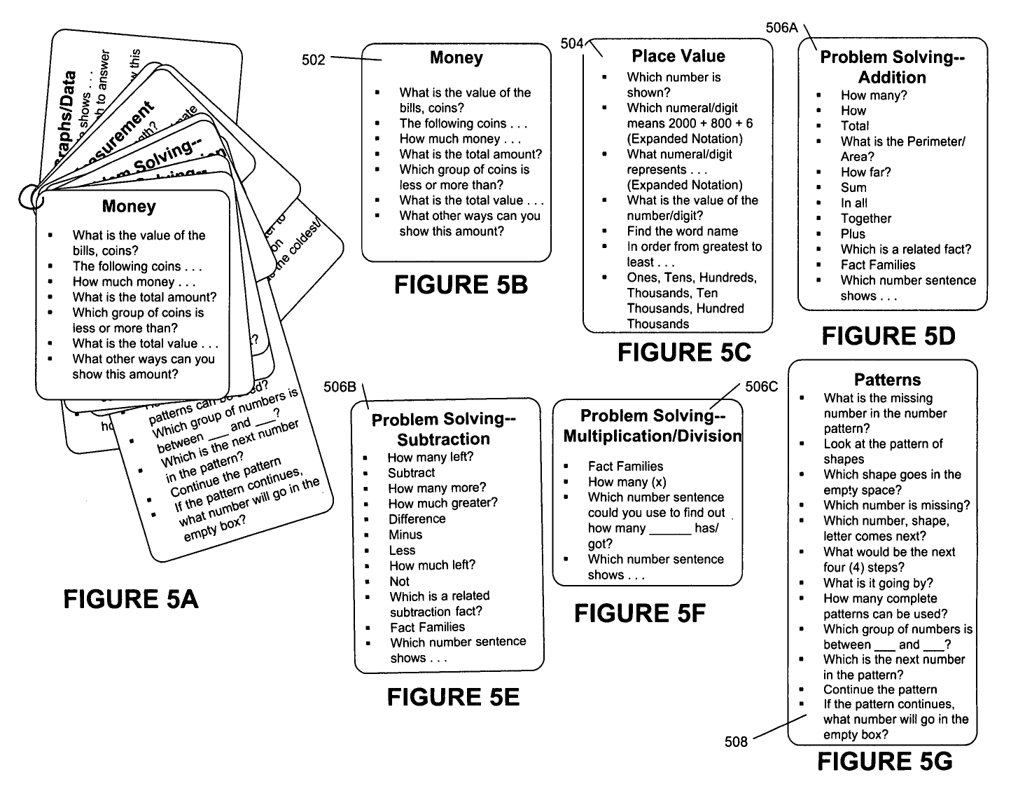

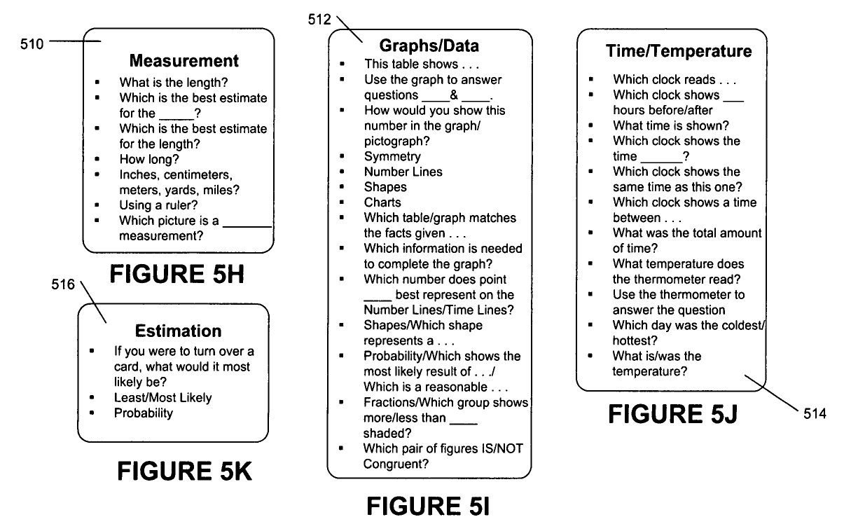

In one embodiment, the method involves defining a set of subject measures corresponding to test categories (expectations) for a particular achievement test subject. Learning aids for the identified measures can then be created and provided to the students in a class group. The teacher can then teach students according to the normal curriculum with the learning aids used to connect subject measures with points being discussed as the subject is being presented pursuant to the normal curriculum. Assessment tests are periodically given to the students, and charts are provided for them to track their performances for each of the defined (or selected) measures. Each student, based on his/her assessment test results, can then use the learning aids to focus on the measure areas where they are having the most problems. In the following sections, specific aspects of these acts are addressed. For convenience and ease of understanding, the reading example (FIGS. 1 through 3), alone, is discussed, but the same or similar principles apply equally to the math example (FIGS. 4 through 6).

Subject Measures

With exemplary reference to FIG. 1, the definition (or selection) of measures from a plurality of test subject categories will now be discussed. There are typically numerous different categories for each subject in an achievement test. For example, with the current grade three TAKS test for reading, there are sixteen different categories on which questions are based for testing the students. It has been found, however, that at least with younger students, such a large number of expectations is difficult to work with for test preparation. It is confusing for them to tackle all sixteen areas in preparing for the test, especially in connection with normal classroom instruction. Accordingly, a smaller number of measures corresponding to the larger number of test categories should be identified. For example, with sixteen categories, 5 to 9 measures may be effective. With the embodiment of FIG. 1, six measures including Graphics Organizers 102, Setting 104, Problems 106, Main Idea 108, Genres 110, and Context Clues 112 are defined) for the sixteen TAKS test categories. Students can more readily get a handle on the smaller number of measures than on the larger set of categories, and by understanding the measures, they are actually indirectly understanding most if not all of the important test categories.

In selecting (or defining) measures, one should take into account different considerations including the following factors. Measures should be selected that map to expectations with significant coverage on the test. Stated another way, measures should be selected without omitting important expectations from a test frequency standpoint. Both assessment and actual TAKS achievement tests, (corresponding to the sixteen categories of FIG. 1) generally include 25 to 35 questions directed to the 16 different categories. Consequently, each category will normally be represented with 1 to 3 test questions, depending on the desires of a particular test's creator. Therefore, it is useful to select measures, at least in part, that cover categories frequently represented on the tests. With only 25 to 35 questions and sixteen different categories, some categories will be tested more frequently than others. Therefore, it is important to focus on at least those categories that are frequently tested.

In addition, measures that efficiently cover more than one expectation should be identified. For example, with the example of FIG. 1, both the Context Clues 112 and Graphics Organizers 102 measures cover (or map to) two separate categories. In fact, with the depicted categories, even more categories may be mapped to the defined measures. This “mapping,” of course, is a subjective decision usually made by an instructor to fit the particular needs of a class group. Measure definitions are certainly not fixed and may be updated from year to year or even from quarter to quarter.

Moreover, some of the categories will be easier for students to grasp than others. and thus may not need to be addressed in a measure. For example, category 7, which involves reading from a wide variety of genres in both print and electronic form, is fairly straight-forward. Covering it in a measure might do more to confuse the students than to help them with this category.

Finally, measures should be selected that cover the more difficult expectations-especially when they have a relatively high question frequency on the test.

Learning Aids

Once a set of measures has been identified, learning aids can be created for helping the students to better understand the categories covered by the measures. As used herein, a learning aid, such as a card or desktop graphic, will generally include conveniently displayed textual information explaining, exemplifying, elaborating upon and/or highlighting aspects of a measure. They can be implemented in any suitable device or format such as, for example, a card, laminated sheet, desktop graphic, decal, bookmark, or the like. In addition, different colors or patterns can be used to appeal to student sensitivities and can make it easier to distinguish between different sets of aids. Normally, a set of learning aids will include at least one aid (such as a card) for each measure that is utilized. Such a set of “measure” learning aids is usually configured so that a student can easily access a desired aid for a desired measure.

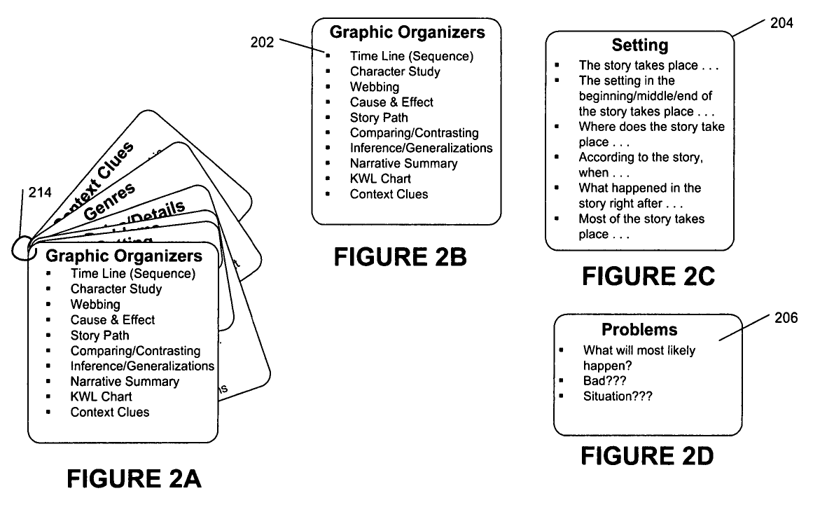

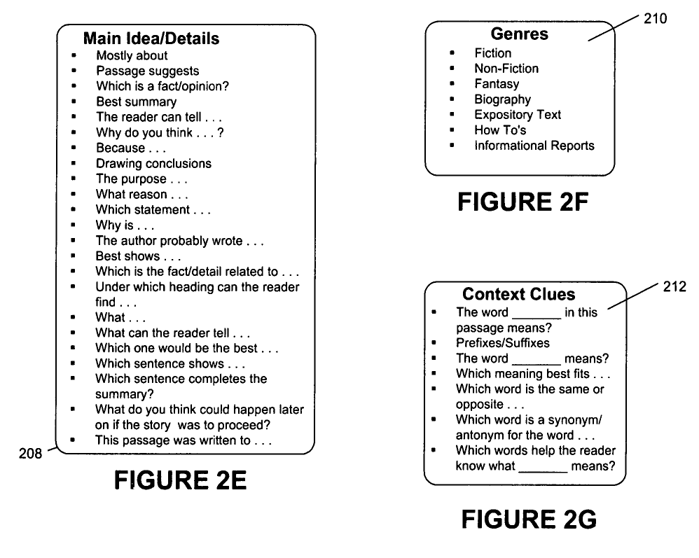

With reference to FIGS. 2A-2G, exemplary measure learning aid flip charts, 202-212, for the set of reading measures of FIG. 1 is shown. With this example, the flip charts are implemented with laminated sheets individually sized to accommodate a desired amount of text for a particular measure but conforming to similar dimensions so as to conveniently stack together and be bound by a connecting ring 214, as is shown in FIG. 2A. With such flip charts, students can flip/turn to the measure and point to a questioning strategy. As seen in FIGS. 2B-2G, an aid sheet for each measure is implemented with text for various purposes including providing examples, summary explanations, and reminders perhaps associated with a lesson to be taught by a teacher. It should be remembered that they can include any suitable text depending upon the particular needs of a student group, the subject, and/or the subject measure. It is important, though, to limit the amount of depicted information so as not to overwhelm a student.

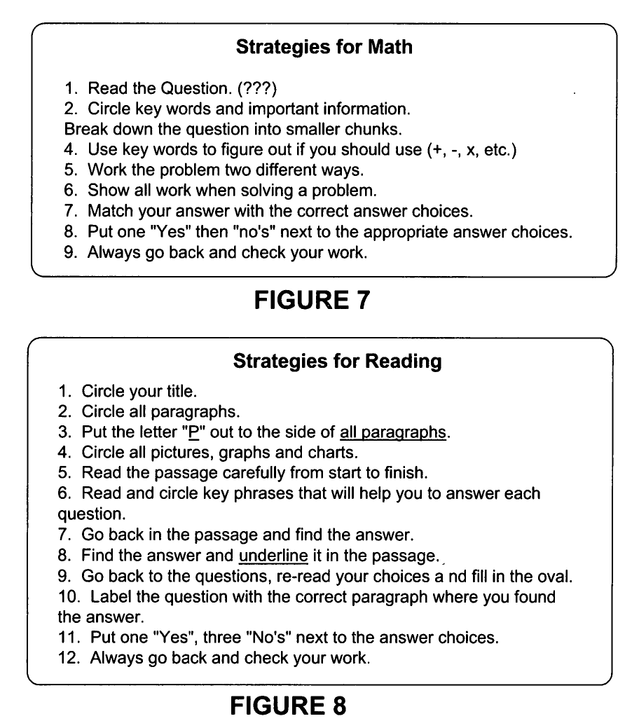

Another type of learning aid is a strategies aid, such as the ones depicted in FIGS. 7 and 8. A strategies aid contains simple and concise instructions for taking an achievement test in a particular subject. The strategies aids of FIGS. 7 and 8 are for math and reading, respectively, and are implemented with a laminated sheet that is taped to a student's desktop.

Assessment Tests and Charting

Assessment tests are typically given on a periodic basis, e.g., once each quarter (or trimester) to provide actual test-taking experience to the students and to track their ability to successfully take and pass the achievement test. It is common for a school district to provide assessment tests to their teachers. Normally, they closely resemble actual achievement tests and typically are derived from tests used in previous years. When scored, assessment tests have conventionally been broken down to identify a student's score for each category. However, this information can be misleading because with only 1 to 3 questions for each category, sample sizes are normally too small to elicit meaningful information from the results. This problem is redressed with the use of measures because by evaluating measures rather than specific categories, sample sizes increase thereby providing more useful information. In one embodiment, scores from the separate categories mapping to each measure are averaged together resulting in a “measure” score. However, depending upon the desires of an instructor or designer, different categories in a measure can be weighted differently, for example, to reflect different question frequencies or importance.

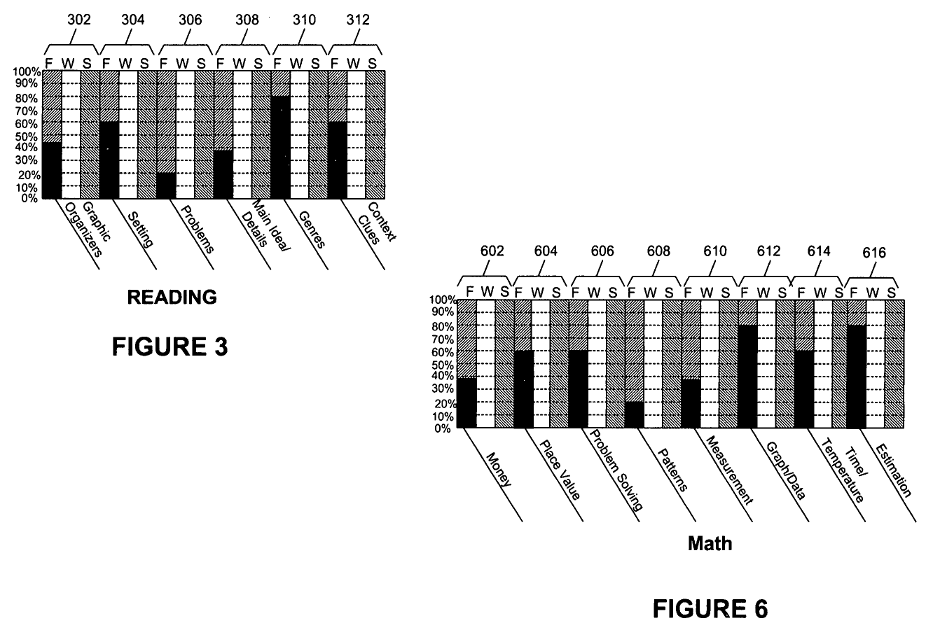

A chart, such as the chart depicted in FIG. 3, is then used to track a student's assessment test performance throughout the school year. The chart tracks the student's strengths and weaknesses over a period of time. A suitable chart will typically have separate measure scales to indicate test scores for the different measures and within these scales, multiple sub-scale's for the different assessment tests given throughout the year. The chart of FIG. 3 is a bar graph having six separate measure scales (or bar sets in this case) 302-312 for the six separate measures used in the reading example of FIGS. 1 and 2A-G. With the depicted bar chart, each measure set includes three separate sub-scale bars for individually tracking student scores for Fall, Winter, and Spring. It should be appreciated that while bar graphs are used in this example, any suitable graph, chart, or diagram type may be used to track student measure scores. In one feature of the disclosed teaching method, after assessment tests have been administered and scored, each student fills in his or her own chart when apprised of his/her measure scores for a assessment test. This serves several functions. First, most students take more of an interest in their scores and with their improvement when they are more actively involved in the overall charting process. Second, it serves to aid them in better understanding charting principles, which enhances their abilities in math, for example, and also allows them to better understand their scores and score breakdowns as they are used in the classroom from day to day. Consequently, in selecting a chart form, one should take into account the ability of students to be able to use and understand the selected chart form.

Day to Day Instruction

Normally, in the beginning of the year, a assessment test is given to the class group(s) to determine where each student is regarding his/her understanding of the separate subject measures (and thus categories). After the assessment test is graded and scored for the selected (or defined) measures, the students receive their measure scores and are instructed to fill in their charts accordingly. after this, when the subject is presented to the class group, e.g., on a daily basis, each student is provided with his/her chart. That is, the student may keep it for his/her desired reference as needed or the charts may be provided to the students on a periodic basis.

By charting and understanding their measure scores, the students become aware of their problematic measures, i.e., the ones for which they have the most difficulty and thus require most of their attention. With this knowledge, they can pay special attention to their problematic measures and with the assistance of the visual aids, get the most out of everyday classroom instruction—specially with regard to their problematic measure areas. They may do this on their own as the subject curriculum is being taught and/or the instructor may point out which measures are invoked as the curriculum instruction occurs. This process is repeated each quarter with the students typically bringing up their problematic measure scores throughout the year making them much more prepared for taking and passing the achievement test. In fact, with the techniques discussed herein, students have performed remarkably well, especially when compared with students from class groups not taught with these methods.

Although the invention has been described with reference to specific examples, it would be appreciated by those skilled in the art that the invention may be embodied in many other forms. Accordingly, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows

1. A method for preparing a class group of students for taking an achievement test in a subject, wherein the test includes a plurality of questions directed to a plurality of different test subject categories relating to the subject, comprising:
defining a set of subject measures, each measure corresponding to one or more of the subject categories, the number of subject measures in the set being sufficiently less than the number of different subject categories;
providing to each student a learning aid for each measure;
presenting to the students one or more assessment tests throughout a school year in preparation for the achievement test;
administering to each student a chart to track his/her performance for each measure on the assessment tests;
causing the students to use the learning aids in connection with the charted measure scores when the subject is being taught to the class group.

2. The method of claim 1, wherein the act of administering to each student a chart includes causing the students to make entries in their charts for tracking their assessment measure performances.

3. The method of claim 1, wherein the subject is reading.

4. The method of claim 3, wherein the measures include a context measure, a main idea measure, and a graphics organizers measure.

5. The method of claim 4, wherein the measures further comprise a setting measure, a problems measure, and a genre measure.

6. The method of claim 1, wherein the subject is math.

7. The method of claim 6, wherein the measures include a place value measure, a problem solving measure, and a patterns measure.

8. The method of claim 7, wherein the measures further comprise a measurement measure, a graphic data measure, and an estimation measure.

9. A kit for preparing a student to pass an achievement test in a subject, the test including a plurality of questions directed to a plurality of different subject categories relating to the subject, the kit comprising:
at least one learning aid corresponding to each measure in a set of subject measures, wherein each measure corresponds to one or more test subject categories with the number of subject measures in the set being sufficiently less than the number of different test subject categories; and
a chart to allow the student to track its performance for each measure on a plurality of assessment tests to be administered to the student.

10. The kit of claim 9, wherein the chart is a bar graph with a plurality of columns to be filled in by the student after completing a assessment test.

11. The kit of claim 9, wherein the subject is reading.

12. The kit of claim 11, wherein the measures include a context measure, a main idea measure, and a graphics organizers measure.

13. The kit of claim 12, wherein the measures further comprise a setting measure, a problems measure, and a genre measure.

14. The kit of claim 9, wherein the subject is math.

15. The kit of claim 14, wherein the measures include a place value measure, a problem solving measure, and a patterns measure.

16. The kit of claim 15, wherein the measures further comprise a measurement measure, a graphic data measure, and an estimation measure.

17. The kit of claim 9, wherein the at least one learning aid includes a plurality of reference cards including a reference card for each subject measure.

18. The kit of claim 17, wherein the reference cards each comprise conveniently presented, summary information relating to a subject measure.

19. A method for preparing a student in a student group to take an achievement test in a particular subject, comprising:
causing the student to take a assessment test corresponding to the achievement test, the assessment and achievement tests having questions directed to a plurality of test categories;
defining a set of measures that map to the plurality of categories, the number of measures in the set being sufficiently less than the plurality of categories;
evaluating the student's assessment test performance for each defined measure;
causing the student to chart its performance for each evaluated measure;
providing to the student a plurality of learning aids including a learning aid for each measure;
instructing the student in the test subject pursuant to a normal class group curriculum; and
causing the student to use the learning aids during the normal class group instruction to correlate aspects of the normal instruction with the defined measures as identified in the learning aids.

20. The method of claim 19, wherein the act of providing to the student a plurality of learning aids includes providing a test strategies aid for the tested subject.
